(19) United States
(12) Patent Application Publication
(10) Pub. No.: US 2020/0309386 A1
(43) Pub. Date: Oct. 1, 2020

(54) SOLAR ASSISTED WATER HEATING SYSTEM FOR ELECTRIC WATER HEATER

(71) Applicant: CHIU-FU LIN, TAICHUNG CITY (TW)

(72) Inventor: CHIU-FU LIN, TAICHUNG CITY (TW)

(21) Appl. No.: 16/828,110

(22) Filed: Mar. 24, 2020

(30) Foreign Application Priority Data
Mar. 29, 2019 (TW) 108111252

(51) Int. Cl. F24D 17/00; F24S 10/70; F24S 60/30; H02S 40/44; H02S 40/30

(52) U.S. Cl. CPC F24D 17/0068; F24S 10/70; H02S 40/30; H02S 40/44; F24S 60/30

(57) ABSTRACT

A solar assisted water heating system for an electric water heater is provided to include a water guiding unit, a solar conversion unit, a radiant energy collection unit, and a pump. When electrical energy from the solar conversion unit is being applied to the pump, the water is driven by the pump to flow into the water guiding unit so as to be heated by the radiant energy collection unit which absorbs sunlight.

### CROSS-REFERENCE TO RELATED APPLICATION

This application claims priority from Taiwanese invention patent application no. 108111252, filed on Mar. 29, 2019.

### FIELD

The disclosure relates to an electric water heater, more particularly to a solar assisted water heating system for an electric water heater.

### BACKGROUND

An existing electric water heater, due to large electricity consumption, is usually set to work in a heavy use time period (such as in the morning or at night).

When hot water is needed at daytime between the heavy use time periods, the electric water heater is manually turned on to heat the water, which may cause additional electricity consumption.

A solar water heater (including a heater and a water storage tank) can convert sunlight into heat for heating the water. The solar water heater includes solar thermal collector plates which occupy a quite large space. Thus, the solar water heater can be installed on the roof of a building, but not at an apartment unit of a building.

A pump of the solar water heater may be automatically turned on and off using a timing switch, or using a temperature sensor unit.

When the timing switch is used, at the predetermined time period, the water from the pump may be heated by the solar thermal collector plates and then be stored in the water storage tank. However, the pump will be still operated when no sunlight is available. In this case, the water from the pump, passing over the solar thermal collector plates, is still cool and may reduce the water temperature inside the water storage tank when introduced into the water storage tank.

When the temperature sensor unit is used, a plurality of temperature sensors are installed inside and outside the water storage tank, and the pump is operated only when there is a predetermined temperature difference between the outdoor temperature and the water temperature inside the water storage tank.

However, the temperature sensor unit is less likely to be used with the existing electric water heater for heating the water using the solar thermal collector plates during the daytime since it is difficult to install the sensors of the temperature sensor unit inside the water storage tank of the existing electric water heater. Furthermore, the timing switch may not always properly work for heating the water using sunlight.

### SUMMARY

Therefore, an object of the disclosure is to provide a solar assisted water heating system which may solve at least one problem of the prior art. With provision of the solar assisted water heating system which is in connection with an electric water heater, a pump may properly work to permit water to be heated by a radiant energy collection unit when sunlight is available.

According to the disclosure, a solar assisted water heating system for an electric water heater is provided to include a water guiding unit, a solar conversion unit, a radiant energy collection unit, and a pump. The water guiding unit includes a water inlet portion for introducing water into the water guiding unit, a water heating portion disposed downstream of the water inlet portion, and a water outlet portion disposed downstream of the water heating portion for discharging the water. The solar conversion unit is disposed outside the water guiding unit, and is configured to convert solar energy into electrical energy. The radiant energy collection unit is disposed on the water heating portion, and is configured to absorb sunlight for heating the water inside the water heating portion. The pump is disposed upstream of the water inlet portion to drive the water to flow into the water guiding unit through the water inlet portion, and is connected electrically to the solar conversion unit such that the water is driven by the pump to flow into the water guiding unit when the electrical energy from the solar conversion unit is being applied to the pump.

With the provision of the solar assisted water heating system, the water inside the electric water heater may be also heated using sunlight, which is useful in saving electrical energy.

### BRIEF DESCRIPTION OF THE DRAWINGS

Other features and advantages of the disclosure will become apparent in the following detailed description of the embodiment(s) with reference to the accompanying drawings, in which:

FIG. 1 is a schematic perspective view of a solar assisted water heating system according to an embodiment of the disclosure;

FIG. 2 is a schematic view illustrating electrical connections among a solar conversion unit, a radiant energy collection unit, a pump, and a voltage stabilizer of the solar assisted water heating system;

FIG. 3 is a schematic view illustrating a water flow between an electric water heater and the solar assisted water heating system during daytime; and

FIG. 4 is similar to FIG. 3 but illustrating a water flow at night.

### DETAILED DESCRIPTION

Before the disclosure is described in greater detail, it should be noted that where considered appropriate, reference numerals have been repeated among the figures to indicate corresponding or analogous elements, which may optionally have similar characteristics.

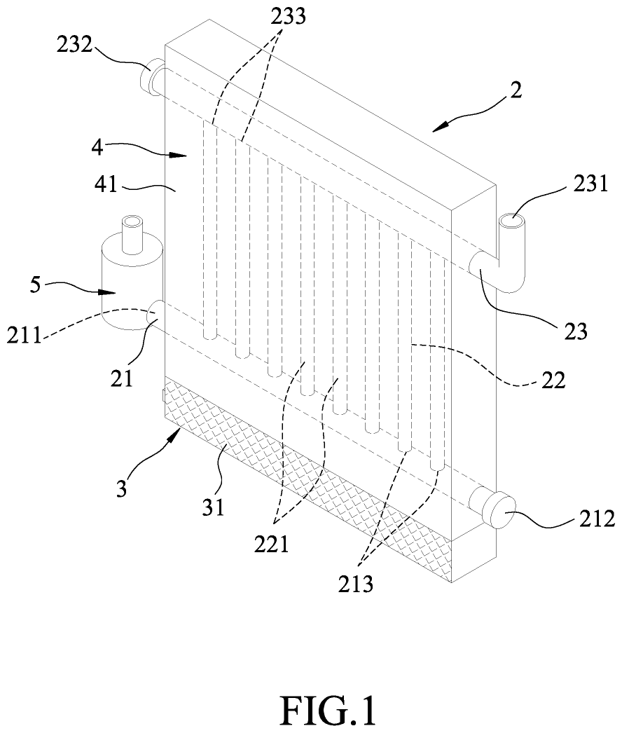

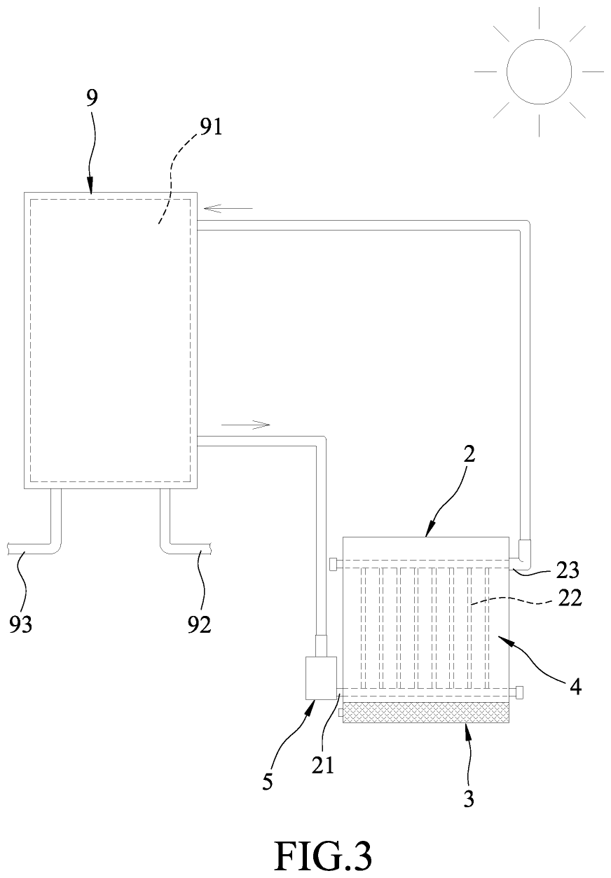

Referring to FIGS. 1 to 3, a solar assisted water heating system according to an embodiment of the disclosure is in connection with an electric water heater 9 and is shown to include a water guiding unit 2, a solar conversion unit 3, a radiant energy collection unit 4, and a pump 5. The electric water heater 9 includes a water storage tank 91 for storing water therein, a cool water supplying pipe 92, and a hot water supplying pipe 93.

The water guiding unit 2 includes a water inlet portion 21 for introducing water into the water guiding unit 2, a water heating portion 22 disposed downstream of the water inlet portion 21, and a water outlet portion 23 disposed downstream of the water heating portion 22 for discharging the water. In an embodiment shown in FIGS. 1 to 3, each of the water inlet and outlet portions 21, 23 may be a pressure and temperature resistant tube which extends in a longitudinal direction. The water inlet portion 21 may include a water inlet port 211 for introducing the water, a first closed end 212 opposite to the water inlet port 211 in the longitudinal direction, and a plurality of first communication ports 213 disposed between the water inlet port 211 and the first closed end 213. The water outlet portion 23 is separated from the water inlet portion 21 in a transverse direction relative to the longitudinal direction, and may include a water outlet port 231 for discharging the water, a second closed end 232 opposite to the water outlet port 231 in the longitudinal direction, and a plurality of second communication ports 233 disposed between the water outlet port 231 and the second closed end 232. The water heating portion 22 may include eight communication tubes 221 which may be made of metal. Each of the communication tubes 221 extends in the transverse direction, and interconnects one of the first communication ports 213 and a respective one of the second communication ports 233. The water guiding unit 2 may accommodate 80 liters of water. However, the total water volume for the water guiding unit 2 and the number of the communication tubes 221 should not be limited to this embodiment.

The solar conversion unit 3 is disposed outside the water guiding unit 2, and is configured to convert solar energy into electrical energy. In an embodiment, the solar conversion unit 3 may include a solar panel 31 which convert solar energy into a direct current voltage ranging from DC 17V to DC 56V.

The radiant energy collection unit 4 is disposed on the water heating portion 22, and is configured to absorb sunlight for heating the water inside the water heating portion 22. In an embodiment, the radiant energy collection unit 4 may include a solar thermal collector panel 41 which, for a non-limiting example, may have the same width and length (80 cm).

The pump 5 is disposed upstream of the water inlet portion 22 to drive the water to flow into the water guiding unit 2 through the water inlet portion 21, and is connected electrically to the solar conversion unit 3 such that the water is driven by the pump 5 to flow into the water guiding unit 2 when the electrical energy from the solar conversion unit 3 is being applied to the pump 5. In a non-limiting embodiment, a voltage for driving the 5 may be DC 12V.

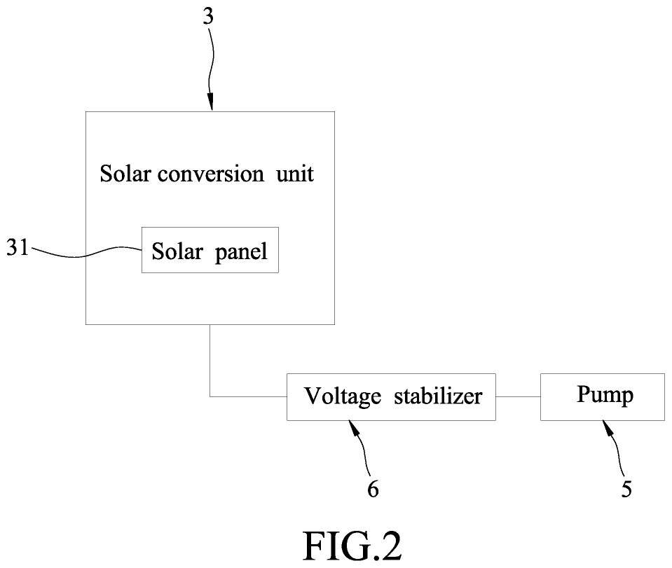

In an embodiment shown in FIG. 2, the solar assisted water heating system may further include a voltage stabilizer 6 which is electrically connected between the solar conversion unit 3 and the pump 5, and which is configured to permit the electrical energy applied to the pump 5 to be within a predetermined voltage range. In a non-limiting embodiment, the predetermined voltage range may be DC 12V to DC 15V.

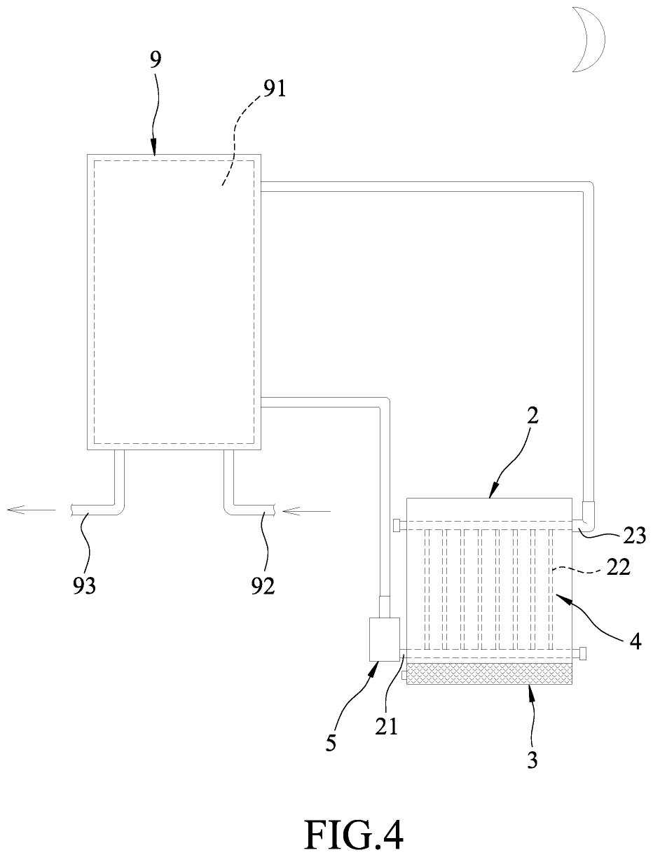

In the case that the electric water heater is set to heat the water at night, as shown in FIGS. 1, 2, and 4, the cool water is introduced into the water storage tank 91 through the cool water supplying pipe 92, and the water heated in the water storage tank 91 is outputted through the hot water supplying pipe 93 for usage. Since sunlight is not available, the solar assisted water heating system will not operate.

During daytime, as shown in FIGS. 1 to 3, the electric water heater may not work to heat the water inside. If sunlight is available, the solar panel 31 converses solar energy into electrical energy, and the voltage of the electrical energy is limited by the voltage stabilizer 6 to be in the predetermined voltage range. Therefore, the pump 5 is driven by the electrical energy from the voltage stabilizer 6 to permit the water inside the water storage tank 91 to flow into the water guiding unit 2 through the water inlet portion 21. During passage of the water through the water heating portion 22, the water is heated by the radiant energy collection unit 4 which is exposed to and absorbs sunlight. Thereafter, the heated water flows upward out of the water guiding unit 2 through the water outlet portion 23 and back to the water storage tank 91. As such, the water inside the water storage tank 91, which continuously flows through the water guiding unit 2 when the sunlight is available, may be continuously heated. Therefore, if a user needs hot water during daytime, it may be unnecessary to manually turn on the electric water heater to heat the water, which is useful in saving energy.

In addition, since the solar-assisted water heating system may have sufficient time for heating water during daytime, a large instantaneous power for heating water is not necessary. In the solar-assisted water heating system, the power is only used to drive the pump 5. Therefore, a space for installation of the solar panel 31 may be small, as long as the solar panel 31, which may be placed in an indoor area, is exposed to sunlight radiation. Therefore, the solar-assisted water heating system is suitable for any residential buildings with access to sunlight radiation.

In the case that the solar-assisted water heating system is placed above or far away from the electric water heater 9, the pump 5 is useful to keep the continuously flow in a correct direction.

It should be noted that although the solar assisted water heating system in the embodiment is used for the electric water heater 9, in other embodiments, the solar assisted water heating system, due to the small size thereof, may be carried out to be used in a camper car or in the wild.

Furthermore, when the sunlight is available, the water heating by the radiant energy collection unit 4 and the operation of the pump 5 are implemented at the same time. When the sunlight is unavailable, the pump 5 stops operating, and the radiant energy collection unit 4 stops heating the water. Therefore, the heated water inside the water storage tank 91 may be prevented from being cooled by unheated water.

Because operation of the pump 5 is determined by sunlight, a timing switch or a temperature sensor unit used in the conventional solar water heater is not necessary for the embodiment of the disclosure.

In sum, with the provision of the solar assisted water heating system, the water inside the electric water heater may be also heated using sunlight during daytime, which is useful in saving electrical energy.

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A solar assisted water heating system for an electric water heater, comprising:
a water guiding unit including
a water inlet portion for introducing water into said water guiding unit,
a water heating portion disposed downstream of said water inlet portion, and
a water outlet portion disposed downstream of said water heating portion for discharging the water;
a solar conversion unit disposed outside said water guiding unit, and configured to convert solar energy into electrical energy;
a radiant energy collection unit disposed on said water heating portion, and configured to absorb sunlight for heating the water inside said water heating portion; and
a pump which is disposed upstream of said water inlet portion to drive the water to flow into said water guiding unit through said water inlet portion, and which is connected electrically to said solar conversion unit such that the water is driven by said pump to flow into said water guiding unit when the electrical energy from said solar conversion unit is being applied to said pump.

2. The solar assisted water heating system according to claim 1, wherein said solar conversion unit includes a solar panel.

3. The solar assisted water heating system according to claim 1, wherein said radiant energy collection unit includes a solar thermal collector panel.

4. The solar assisted water heating system according to claim 1, further comprising a voltage stabilizer which is electrically connected between said solar conversion unit and said pump, and which is configured to permit the electrical energy applied to said pump to be within a predetermined voltage range.
